(19) United States
(12) Patent Application Publication
(10) Pub. No.: US 2012/0215525 A1
(43) Pub. Date: Aug. 23, 2012

(54) METHOD AND APPARATUS FOR MIXED DIMENSIONALITY ENCODING AND DECODING

(75) Inventors: Sanxin JIANG, Shanghai (CN); Peilin LIU, Shanghai (CN); Rendong YING, Shanghai (CN); Wei XIAO, Shenzhen (CN)

(73) Assignee: HUAWEI TECHNOLOGIES CO., LTD., Shenzhen (CN)

(21) Appl. No.: 13/457,238

(22) Filed: Apr. 26, 2012

Related U.S. Application Data
(63) Continuation of application No. PCT/CN2010/080410, filed on Dec. 28, 2010.

(30) Foreign Application Priority Data
Jan. 13, 2010 (CN) 201010042764.9

(51) Int. Cl. G10L 19/02

(52) U.S. Cl. 704/205; 704/E19.011

(57) ABSTRACT

A method and apparatus for mixed dimensionality encoding and decoding are provided in embodiments of the present invention. The method includes: obtaining at least one variable collection through calculation according to a processed spectral coefficient, determining a processing dimension for a spectral coefficient to be processed, according to a relationship between the at least one variable collection and a corresponding threshold collection, and performing, according to a selected dimension, encoding or decoding under the dimension on the spectral coefficient to be processed. Through the preceding technical means, different processing dimensions are used for different spectral coefficients, improving the encoding and decoding efficiency.

### CROSS-REFERENCE TO RELATED APPLICATIONS

This application is a continuation of International Application No. PCT/CN2010/080410, filed on Dec. 28, 2010, which claims priority to Chinese Patent Application No. 201010042764.9, filed on Jan. 13, 2010, both of which are hereby incorporated by reference in their entireties.

### FIELD OF THE INVENTION

The present invention relates to an encoding and decoding technology field, and in particular, to a method and apparatus for mixed dimensionality encoding and decoding.

### BACKGROUND OF THE INVENTION

Context-based algorithm encoding is a high-performance lossless compression processing method. This method takes advantage of the short-term stability of a signal to establish statistical models that describe a plurality of neighboring frames or the relevance of neighboring frames, select an optimal model in real time through analysis, and yield a high-efficiency lossless encoding effect. Context (context) indicates a coefficient of encoding and decoding obtained before a current coefficient to be encoded and decoded, based on the fact that a certain connection exists between corresponding frequencies of neighboring frames or neighboring frequencies of a same frame.

Unified speech and audio coding (Unified Speech and Audio Coding, USAC) is a standard being formulated by the moving picture experts group (Moving Picture Experts Group, MPEG). The USAC standard uses context-based algorithm encoding. In this method, every four spectral coefficients in an ascending sequence of frequency of each frame form a group, forming a 4-dimensional vector space 4-tuples, which is the encoding object.

During implementation of the present invention, the inventor finds that: the 4-tuples fixed dimensionality encoding and decoding method used in the prior art restricts the improvement of the encoding and decoding efficiency.

### SUMMARY OF THE INVENTION

A method and apparatus for mixed dimensionality encoding and decoding provided in embodiments of the present invention use different dimensionalities for different spectral coefficients, and improve the encoding and decoding efficiency through multi-dimensional mixed encoding and decoding.

A method for mixed dimensionality encoding and decoding is provided in an embodiment of the present invention. The method includes:

obtaining at least one variable collection through calculation according to a processed spectral coefficient;

determining a processing dimensionality for a spectral coefficient to be processed, according to a relationship between the at least one variable collection and a corresponding threshold collection; and performing, according to a selected dimensionality, encoding or decoding under a selected dimensionality on the spectral coefficient to be processed.

An apparatus for mixed dimensionality encoding and decoding is provided in an embodiment of the present invention. The apparatus includes:

a variable acquiring module, configured to obtain at least one variable collection through calculation according to a processed spectral coefficient;

a dimensionality determining module, configured to determine a processing dimensionality for a spectral coefficient to be processed, according to a relationship between the at least one variable collection and a corresponding threshold collection; and

an encoding and decoding module, configured to perform, according to a selected dimensionality, encoding or decoding under the dimensionality for the spectral coefficient to be processed.

The technical scheme provided in the embodiment of the present invention adopts the technical means of obtaining at least one variable collection through calculation according to a processed spectral coefficient, determining a processing dimensionality for a spectral coefficient to be processed, according to a relationship between the at least one variable collection and a corresponding threshold collection, and performing, according to a selected dimensionality, encoding or decoding under the dimensionality on the spectral coefficient to be processed, and uses different processing dimensionalities for different spectral coefficients, improving the encoding and decoding efficiency.

### BRIEF DESCRIPTION OF THE DRAWINGS

To illustrate the present invention or technical solution more clearly, the drawings that need to be used in the present invention are described briefly in embodiments of the present invention. It is understandable that the drawings merely provide several applications of the present invention. Those skilled in the art may obtain other drawings based on these drawings without innovative work.

FIG. 1 is a schematic diagram of a context model provided in an embodiment of the present invention;

FIG. 2 is a flowchart of a method for mixed dimensionality encoding and decoding provided in an embodiment of the present invention;

FIG. 3 is a schematic diagram of a 16-order context model provided in an embodiment of the present invention;

FIG. 4a and FIG. 4b are flowcharts of a method for determining a dimensionality in the method for mixed dimensionality encoding and decoding provided in an embodiment of the present invention;

FIG. 5 is a flowchart of another method for determining a dimensionality in the method for mixed dimensionality encoding and decoding provided in an embodiment of the present invention;

FIG. 6 is a flowchart of an embodiment for determining a dimensionality by combining a position in the method for mixed dimensionality encoding and decoding provided in an embodiment of the present invention;

FIG. 7 is a flowchart of another method for mixed dimensionality encoding and decoding provided in an embodiment of the present invention;

FIG. 8 shows a context model in the embodiment as shown in FIG. 7;

FIG. 9 is a flowchart of the method for determining a dimensionality in the embodiment as shown in FIG. 7;

FIG. 10 shows another context model in the embodiment as shown in FIG. 7;

FIG. 11 is a flowchart of another method for determining a dimensionality in the embodiment as shown in FIG. 7;

FIG. 12 shows another context model in the embodiment as shown in FIG. 7;

FIG. 13 is a flowchart of another method for mixed dimensionality encoding and decoding provided in an embodiment of the present invention;

FIG. 14 is a flowchart of the method for determining the dimensionality in the embodiment as shown in FIG. 13;

FIG. 15 is a flowchart of another method for determining a dimensionality in the embodiment as shown in FIG. 13;

FIG. 16 is a structural diagram of an apparatus for mixed dimensionality encoding and decoding provided in an embodiment of the present invention; and

FIG. 17 is a structural diagram of an apparatus for mixed dimensionality encoding and decoding provided in another embodiment of the present invention.

### DETAILED DESCRIPTION OF THE EMBODIMENTS

The technical solution under the present invention is elaborated below with reference to accompanying drawings. Evidently, the embodiments described below are for the exemplary purpose, without covering all embodiments of the present invention. All other embodiments obtained by those skilled in the art without creative work based on the embodiments of the present invention are in the protection scope of the present invention.

The technical scheme provided in the embodiments of the present invention may be applied at an encoding end and decoding end. To clarify the embodiments, the expressions of encoding and decoding are unified as processing. Therefore, spectral coefficients to be processed in the embodiments include spectral coefficients to be encoded and spectral coefficients to be decoded, and processed spectral coefficients include encoded spectral coefficients and decoded spectral coefficients.

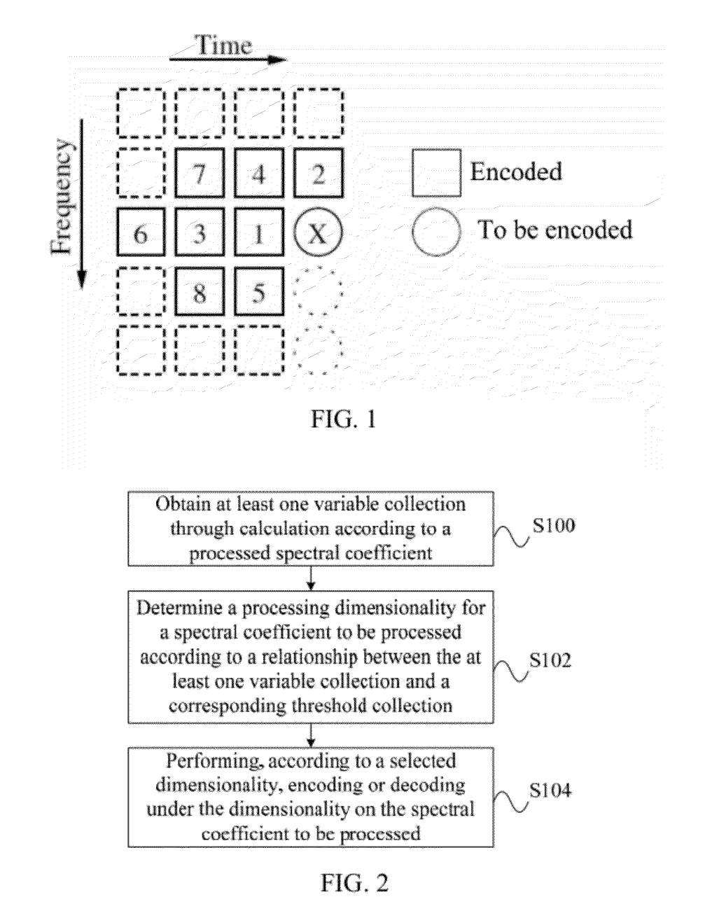

The following provides a context model to outline the context used in the embodiments of the present invention with the help of FIG. 1. Assuming that the current spectral coefficient to be processed is X, the approximate processed spectral coefficients may be used as context. Numbers 1 to 8 in the figure indicate the degrees of relevance between processed spectral coefficients and the spectral coefficient to be processed, where 1 indicates the highest degree of relevance and 8 indicates the lowest degree of relevance. From the figure, it may be seen that the spectral coefficient to be processed is relevant to the approximate spectral coefficients of the frame to be processed, and is also relevant to the processed spectral coefficients of several frames before the frame to be processed. It needs to be noted that FIG. 1 shows an embodiment of a context model. The spectral coefficient to be processed in the figure is X. The processed spectral coefficients 1 to 8 may include N spectral coefficients. N may be an integer equal to or larger than 1. That is, the number of spectral coefficients to be processed that take part in dimensionality selection may be N.

In the embodiments, each frame includes a plurality of spectral coefficients. Before processing the spectral coefficients of each frame, it is required to enter the context first. The entered context may be the context of a previous frame, or the context of previous frames. To save the storage space, only the context of the previous frame may be entered. That is, the context is obtained by mapping the processed spectral coefficients of the previous frame according to the length of the frame to be processed. To simplify description, subsequent embodiments are described by using the example of storing the context of the previous frame. For the implementation method where the spectral coefficients of a plurality of frames are used as the context, reference may be made to the scheme provided in this embodiment, which is not introduced one by one again.

FIG. 2 is a flowchart of a method for mixed dimensionality encoding and decoding. The method includes:

S100: Obtain at least one variable collection through calculation according to a processed spectral coefficient.

S102: Determine a processing dimensionality for a spectral coefficient to be processed, according to a relationship between the at least one variable collection and a corresponding threshold collection.

S104: Perform, according to a selected dimensionality, encoding or decoding under the dimensionality on the spectral coefficient to be processed.

The technical scheme provided in the embodiment of the present invention adopts the technical means of obtaining at least one variable collection through calculation according to a processed spectral coefficient, determining a processing dimensionality for a spectral coefficient to be processed, according to a relationship between the at least one variable collection and a corresponding threshold collection, and performing, according to the selected dimensionality, encoding or decoding under the dimensionality on the spectral coefficient to be processed, and uses different processing dimensions for different spectral coefficients, improving the encoding and decoding efficiency.

The following further describes the method for mixed dimensionality encoding and decoding of the present invention with the help of FIG. 2. The method includes:

S100: Obtain at least one variable collection through calculation according to a processed spectral coefficient.

As stated previously, the number of spectral coefficients to be processed may be N. Before selecting processing dimensionalities for the spectral coefficients to be processed, it is required to determine the number of spectral coefficients to be processed that take part in dimensionality selection. For easy description, subsequent embodiments are described by taking the cases where the number of spectral coefficients to be processed is 4 or 2 for example. The implementation methods in the cases of other numbers of spectral coefficients to be processed can be implemented by referring to the scheme provided in this embodiment, and are not described one by one again.

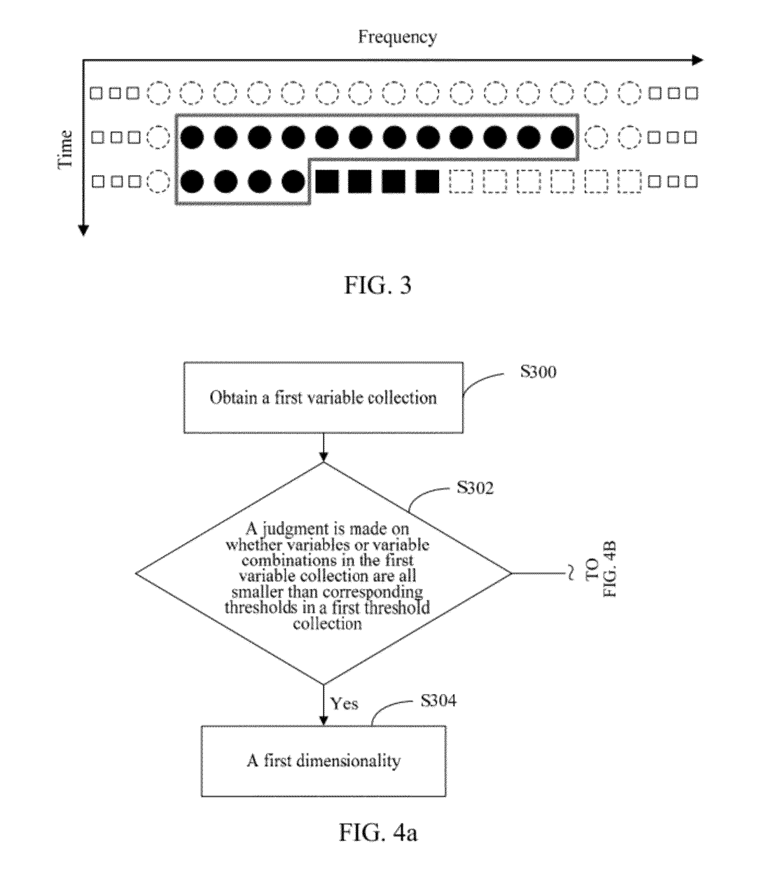

The processed spectral coefficients that are used as the context may be determined after the number of spectral coefficients to be processed is obtained. The following takes the 16-order context model for example. As shown in FIG. 3, the black block indicates the determined spectral coefficients to be processed. The number of spectral coefficients to be processed is 4. The encoded spectral coefficients that serve as the context may be the 12 spectral coefficients of the previous frame indicated in a black circle and the 4 spectral coefficients to be processed.

It needs to be noted that in certain implementation ways, when the preceding 16-order context model is used, if the spectral coefficients to be processed are initial points, zeros may be supplemented to complete the 16 encoded spectral coefficients. In certain implementation ways, the method of distinguishing between positions of the spectral coefficients to be encoded may also be used to solve the problem. Likewise, for other context models, reference may be made to the preceding principles for processing and these context models are not listed one by one in the present invention.

In embodiments of the present invention, the processed spectral coefficients may be determined according to the number of determined spectral coefficients to be processed and the context model, and at least one variable collection can be obtained by calculating the determined processed spectral coefficients.

In embodiments of the present invention, a variable may be a value that denotes the data difference, for example, position, energy, average value, variance, mean square error, minimum variance, slope, divergence factor, and dispersion. It needs to be noted that the variables listed here are for exemplary purposes. All types of variables that can be obtained through calculation according to processed spectral coefficients and configured to achieve the idea of the present invention fall within the protection scope of the present invention. The variables in the variable collection may include a plurality of variables, which may belong to one of the preceding types, or may belong to different types. For example, assuming that the variable collection includes 5 variables, these variables may be 5 energy variables, or may be 2 average value variables and 3 variance variables, or 1 energy variable, 2 average value variables, and 2 variance variables. It may be seen that the types and number of variables in a variable collection may be set according to an actual situation.

S102: Determine a processing dimensionality for a spectral coefficient to be processed, according to a relationship between the at least one variable collection and a corresponding threshold collection.

In embodiments of the present invention, a threshold collection corresponding to the variable collection is set. The threshold collection includes a plurality of thresholds, which are constants whose values may be obtained through experiments.

The scenario of a relationship between at least one variable collection and a corresponding threshold collection includes a plurality of cases. Examples are as follows:

1. A case where one variable collection and one threshold collection exist: In this case, the variables or variable combinations in the variable collection are compared with corresponding thresholds in the threshold collection.

2. A case where two variable collections and two threshold collections exist: The variable collections include a first variable collection and a second variable collection, which are corresponding to a first threshold collection and a second threshold collection respectively. As such, the relationship between at least one variable collection and a corresponding threshold collection is the relationship between the variables or variable combinations in the first variable collection and the corresponding thresholds in the first threshold collection, and the relationship between the variables or variable combinations in the second variable collection and the corresponding thresholds in the second threshold collection. In certain implementation ways, the first threshold collection may be equivalent to the second threshold collection. That is, different variable collections may correspond to a same threshold collection.

3: Other cases: For example, at least three variable collections and at least three threshold collections exist, or the number of variable collections is not the same as the number of threshold collections. These cases may be processed according to the principles provided in embodiments of the present invention, and are not repeated here.

The value of dimensionality indicates the number of spectral coefficients that may be processed at one time. For example, 1-dimensional processing indicates that 1 spectral coefficient is processed at one time, 4-dimensional processing indicates that 4 spectral coefficients are processed at one time, and 16-dimensional processing indicates that 16 spectral coefficients are processed at one time. The value of dimensionality may be determined according to the number of spectral coefficients to be processed. For example, if the number of spectral coefficients to be processed is 2, only 1-dimensional or 2-dimensional processing can be used; if the number of spectral coefficients to be processed is 4, 1-dimensional, 2-dimensional, or 4-dimensional processing can be used; if the number of spectral coefficients to be processed is 16, processing by using more dimensions can be used, for example, 16-dimensional.

In embodiments of the present invention, the number of dimensionalities available for selection is at least 2. The actual number can be determined according to the numbers of variable collections and threshold collections. For example, if only one variable collection and one threshold collection are included, the number of dimensionalities may be 2; if two variable collections and two threshold collections are included, the number of dimensions may be 3; if more collections are included, the number of dimensionalities may be determined according to the actual condition, which is not repeated here.

In embodiments of the present invention, after the value of dimension and the number of dimensions are determined, the scope for selecting the processing dimensions for the spectral coefficients to be processed is determined. The specific method for determining a processing dimensionality for a spectral coefficient to be processed, according to a relationship between the at least one variable collection and a corresponding threshold collection is described in subsequent embodiments.

S104: Perform, according to a selected dimensionality, encoding or decoding under the dimensionality on the spectral coefficient to be processed.

In embodiments of the present invention, after the dimensionalities for the spectral coefficients to be processed are determined, encoding and decoding under relevant dimensions may be performed. For example, if the 4-dimensional processing dimensionality is selected, 4-dimensional encoding may be performed. If the 2-dimensional processing dimensionality is selected, 2-dimensional encoding may be performed. During encoding, if the number of preceding spectral coefficients is 4, during 4-dimensional encoding, 4 spectral coefficients are viewed as one 4-dimensional vector for encoding; during 2-dimensional encoding, 2 spectral coefficients are viewed as one 2-dimensional vector for encoding. As for the specific method for performing, according to a selected dimensionality, encoding and decoding under the dimensionality, reference can be made to the processing in the prior art, and is not repeated here.

The encoding and decoding methods are not confined. Algorithm encoding may be used, and any other lossless encoding, or entropy encoding may also be used. Likewise, a decoding end may also use a plurality of decoding methods.

The technical scheme provided in the embodiment of the present invention adopts the technical means of obtaining at least one variable collection through calculation according to a processed spectral coefficient, determining a processing dimensionality for a spectral coefficient to be processed, according to a relationship between the at least one variable collection and a corresponding threshold collection, and performing, according to a selected dimensionality, encoding or decoding under the dimensionality on the spectral coefficient to be processed, and uses different processing dimensions for different spectral coefficients, improving the encoding and decoding efficiency.

The following is a brief introduction to that the method for mixed dimensionality encoding and decoding improves the encoding and decoding efficiency. Take encoding as an example: context-based encoding obtains a high encoding efficiency with the help of relevance of neighboring coefficients. If the relevance of neighboring coefficients is high, the encoding efficiency is high, and vice versa. For example, four neighboring coefficients are 12, 2, 1, and 2. The relevance between coefficient 12 and other coefficients is not high, therefore unified 4-dimensional joint encoding can hardly find an appropriate probability model, leading to a low efficiency. To deal with this case, the preceding coefficients may be separated: {12}, {2,1,2}. For coefficient 12, a proper processing dimensionality is selected separately for encoding; and for {2,1,2}, a proper processing dimensionality is selected separately for encoding, which improves the efficiency.

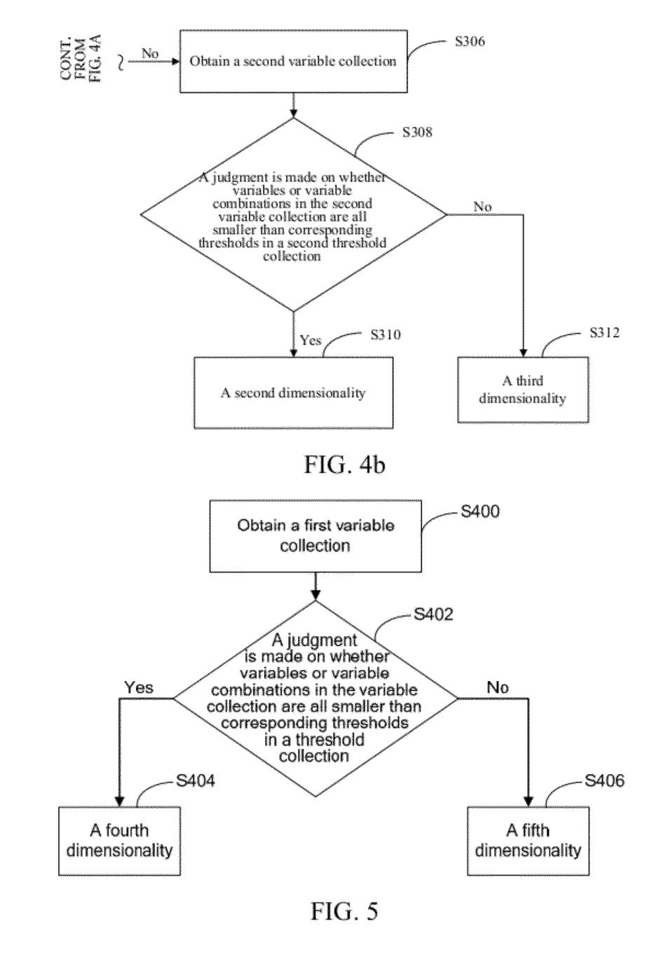

FIG. 4a and FIG. 4b are flowcharts of an embodiment for a method for determining a dimensionality in the method for mixed dimensionality encoding and decoding. As shown in FIG. 4a and FIG. 4b, this embodiment includes:

In this embodiment, the case where the at least one variable collection includes a first variable collection and a second variable collection, and the corresponding threshold collections include a first threshold collection and a second threshold collection is taken as an example to describe the method for obtaining at least one variable collection according to processed spectral coefficients and determining a processing dimensionality for spectral coefficients to be processed, according to a relationship between the at least one variable collection and the corresponding threshold collection. In this embodiment, the number of dimensionalities is 3. The values of dimensionalities are called a first dimensionality, a second dimensionality, and a third dimensionality respectively. As stated previously, the values of dimensionalities may vary, for example, they may be any integers in allowed conditions. The values of the preceding three dimensionalities may be determined during specific implementation. For easy description, this embodiment takes 1-dimensional, 2-dimensional, and 4-dimensional as examples, but these examples do not confine the present invention.

S300: Obtain a first variable collection according to processed spectral coefficients.

S302: Determine whether variables or variable combinations in the first variable collection are all smaller than corresponding thresholds in a first threshold collection; if yes, execute step S304; if no, execute step S306.

S304: Determine a processing dimensionality of a spectral coefficient to be processed as the first dimensionality.

S306: Obtain a second variable collection according to processed spectral coefficients.

S308: Determine whether variables or variable combinations in the second variable collection are all smaller than corresponding thresholds in a second threshold collection; if yes, execute step S310; if no, execute step S312.

S310: Determine the processing dimensionality of the spectral coefficient to be processed as the second dimensionality.

S312: Determine the processing dimensionality of the spectral coefficient to be processed as the third dimensionality.

It needs to be noted that the setting of the comparison relationship does not confine the present invention, and being smaller than may also be being smaller than or equal to.

FIG. 5 is a flowchart of another embodiment for a method for determining a dimensionality in the method for mixed dimensionality encoding and decoding. As shown in FIG. 5, this embodiment includes:

In this embodiment, the case where the at least one variable collection and the corresponding threshold collection include only one variable collection and one threshold collection is taken as an example to describe the method for obtaining at least one variable collection according to processed spectral coefficients and determining a processing dimensionality for spectral coefficients to be processed, according to a relationship between the at least one variable collection and the corresponding threshold collection. In this embodiment, the number of dimensionalities is determined as 2, and the values of the dimensionalities are called a fourth dimensionality and a fifth dimensionality respectively. The actual values of the above two dimensionalities may be determined according to an actual situation during specific implementation.

S400: Obtain a variable collection according to processed spectral coefficients.

S402: Determine whether variables or variable combinations in the variable collection are all smaller than corresponding thresholds in a threshold collection; if yes, execute step S404; if no, execute step S406.

S404: Determine a processing dimensionality of a spectral coefficient to be processed as the fourth dimensionality.

S406: Determine the processing dimensionality of the spectral coefficient to be processed as the fifth dimensionality.

It needs to be noted that the setting of the comparison relationship does not confine the present invention, and being smaller than may also be being smaller than or equal to.

In certain implementation ways, the impact of a position of the spectral coefficient to be processed on determining the dimensionality is considered. That is, the processing dimensionality of the spectral coefficient to be processed is selected according to positions of processed spectral coefficients and the spectral coefficient to be processed. The method for mixed dimensionality encoding and decoding in this embodiment includes: implementing time frequency conversion on input signals to obtain a spectral coefficient to be encoded; according to an ascending sequence of frequency, selecting a processing dimensionality of the spectral coefficient to be processed, according to positions of processed spectral coefficients and the spectral coefficient to be processed; and performing, according to a selected dimensionality, encoding or decoding under the dimensionality.

The position of the spectral coefficient to be processed is the lower coordinate of the spectral coefficient to be processed, and indicates the position in the frame to be processed. In certain cases, the initial spectral coefficients to be processed in the frame to be processed cannot obtain sufficient context for analysis. Therefore, in certain implementation modes, a position threshold can be set to determine different dimensionality selection processes according to a relationship between the spectral coefficient to be processed and the position threshold.

Different dimensionality selection ranges are set for the coefficients to be processed before and after the position threshold. For example, a first range is set for the spectral coefficients to be processed whose positions in the frame to be processed are larger than or equal to the position threshold. The first range may include a plurality of dimensionalities. A second range is set for the spectral coefficients to be processed whose positions in the frame to be processed are smaller than the position threshold. The number of dimensionalities set in the second range may be fewer, and at least one. In certain implementation ways, the dimensionalities in the second range can also be set separately. For example, a range for selecting dimensionalities is set for certain points, and another range for selecting dimensionalities is set for other points. The range for selecting dimensionalities may be determined by using the method in the preceding embodiments. By distinguishing, according to positions, between processing dimensionalities of spectral coefficients to be processed, spectral coefficients in certain special regions may obtain sufficient context for analysis. It needs to be noted that the setting of the comparison relationship does not confine the present invention, and being equal to or greater than may be being greater than, and being smaller than may be being equal to or smaller than.

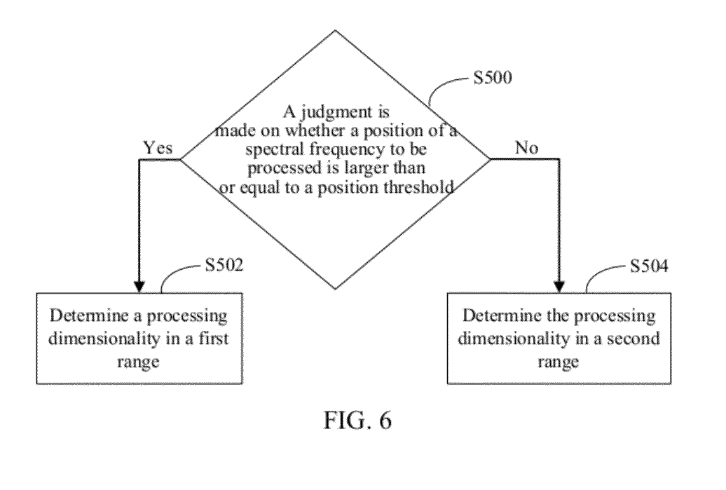

Assuming that the position threshold is 4 (which indicates the fifth coefficient to be processed in the frame to be processed), the following takes a group of values for example to further describe the preceding embodiment with the help of FIG. 6:

S500: Judge whether a position of a spectral coefficient to be processed is larger than or equal to 4; if yes, execute step S502; if no, execute step S504.

S502: Determine a processing dimensionality in a first range as 4-dimensional, 2-dimensional, or 1-dimensional by using the method for selecting processing dimensionalities for a spectral coefficient to be processed, according to processed spectral coefficients provided in the preceding embodiment.

S504: Determine a processing dimensionality in a second range as 2-dimensional or 1-dimensional by using the method for selecting processing dimensionalities for a spectral coefficient to be processed, according to processed spectral coefficients provided in the preceding embodiment.

In certain implementation ways, further division may be made according to the setting of the second range:

If the position of the spectral coefficient to be processed in the frame to be processed is 0 or 2 (that is, the first or third spectral coefficient to be processed in the frame to be processed), the dimensionality selection range is 2-dimensional or 1-dimensional.

If the position of the spectral coefficient to be processed in the frame to be processed is 1 or 3 (that is, the second or fourth spectral coefficient to be processed in the frame to be processed), the dimensionality selection range is 1-dimensional.

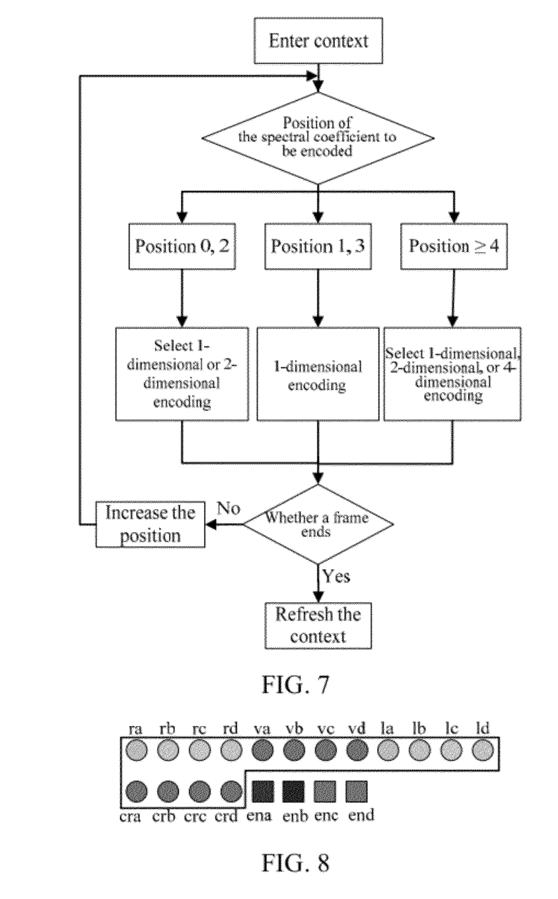

FIG. 7 is a flowchart of another method for mixed dimensionality encoding and decoding provided in an embodiment of the present invention. As shown in FIG. 7, this embodiment takes an encoding end as an example, uses energy as a variable, combines position and energy, and describes the preceding technical scheme by using specific values:

First, context is entered. This context is obtained by mapping the previous encoded frame according to the length of the current frame to be processed. Then, a dimensionality of the spectral coefficient to be encoded is selected according to the position of the current spectral coefficient to be encoded and according to encoded spectral coefficients, and the spectral coefficient to be encoded is encoded according to the selected dimensionality. After the encoding of the current spectral coefficient to be encoded is completed, a position counter increases to update the current spectral coefficient to be encoded. Then, the preceding process of selecting a dimensionality for a spectral coefficient according to the position of the current spectral coefficient to be encoded is repeated until the encoding of the current frame to be encoded is completed. After the encoding of the current frame to be encoded is completed, the context is refreshed to prepare for encoding a next frame.

In this embodiment, when the spectral coefficient to be encoded is in position 0 or 2, the current spectral coefficient to be encoded may select 1-dimensional or 2-dimensional encoding; when the spectral coefficient to be encoded is in position 1 or 3, the current spectral coefficient to be encoded can select 1-dimensional encoding; when the spectral coefficient to be encoded is in a position later than 4, the current spectral coefficient to be encoded may select 4-dimensional encoding, 2-dimensional, or 1-dimensional encoding.

Assuming that the position variable of the current spectral coefficient to be encoded is pst, according to the preceding flowchart, three branch cases are provided below:

Case 1: when pst≧4

The context model is shown in FIG. 8, where: ena, enb, enc, and end are spectral coefficients to be encoded, that is, the number of spectral coefficients to be encoded is 4; other 16 data items, that is, ra, rb, rc, rd, va, vb, vc, vd, la, lb, lc, ld, cra, crb, crc, and crd, are 16 context spectral coefficients of the spectral coefficients to be encoded, that is, the selected encoded spectral coefficients; the 16 encoded spectral coefficients are used to predict the dimensionalities of spectral coefficients to be encoded, that is, ena, enb, enc, and end.

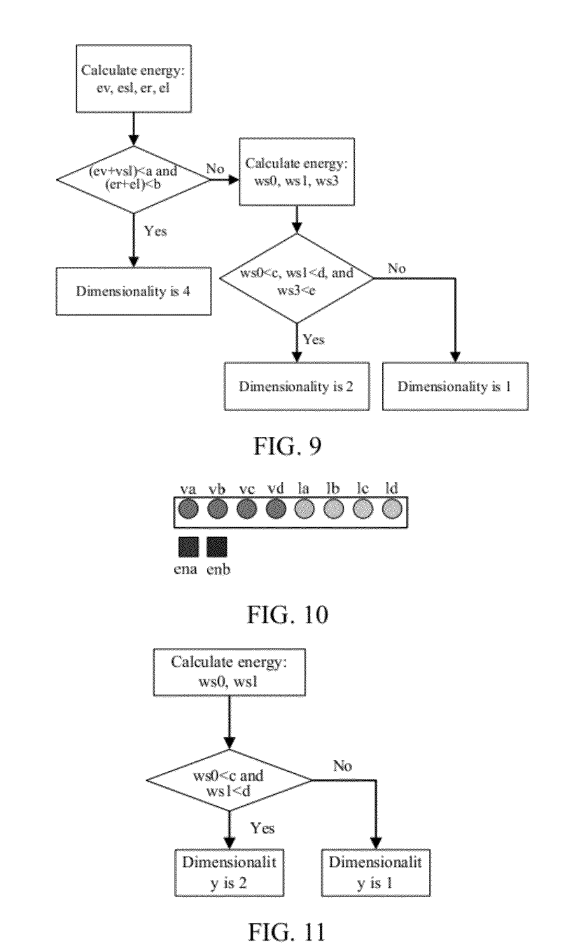

As shown in FIG. 9, in this embodiment, the type of variable is energy. The variable collections include a first variable collection ev, evl, er, el, and a second variable collection ws0, ws1, ws2. The threshold collections include a first threshold collection a, b, and a second threshold collection c, d, e, where a, b, c, d, and e are constants, whose values are obtained through experiments.

Variables ev, esl, er, el, ws0, ws1, and ws2 are energy of a plurality of encoded spectral coefficients in the neighboring areas of the spectral coefficient to be processed. The calculation methods are as follows:

ev=|va|\hat{0}3+|vb|\hat{0}3+|vc|\hat{0}3+|vd|\hat{0}3;

esl=|cra|\hat{0}3+|crb|\hat{0}3+|crc|\hat{0}3+|crd|\hat{0}3;

el=|la|\hat{0}3+‘lb|\hat{0}3+|lc|\hat{0}3+|id|\hat{0}3;

er=|ra|\hat{0}3+|rb|\hat{0}3+|rc|\hat{0}3+|rd|\hat{0}3;

ws0=|va|\hat{0}3+|vb|\hat{0}3+|crc|\hat{0}3+|crd|\hat{0}3;

ws1=|lc|\hat{0}3+|ld|\hat{0}3+|vc|\hat{0}3+|vd|\hat{0}3;

ws2=er+|la|\hat{0}3+|lb|\hat{0}3.

In this embodiment, the thresholds may be set respectively as follows: a=b=8, c=64, d=133, e=216:

If: ra=1, rb=0, rc=0, rd=1; 1.

va=1, vb=0, vc=1, vd=0;

la=0, lb=0, lc=1, ld=0;

cra=0, crb=1, crc=1, crd=0;

Then, through calculation, it is obtained that: ev=2, er=2, el=1, esl=2;

Then: (ev+esl)=4<a and (er+el)=3<b; in this case, 4-dimensional encoding is selected, that is, ena, enb, enc, and end are viewed as a 4-dimensional vector, and encoding is performed according to the 4-dimensional vector.

If: ra=1, rb=0, rc=0, rd=1; 2.

va=1, vb=0, vc=1, vd=0;

la=2, lb=0, lc=1, ld=0;

cra=0, crb=1, crc=1, crd=0;

Then, through calculation, it is obtained that: ev=2, er=2, el=8, esl=2;

Then: (ev+esl)=4<8 and (er+el)=9>8; in this case, only 2-dimensional or 1-dimensional encoding can be selected.

Through further calculation, it is obtained that:

ws0=2, ws1=2, ws2=10

In this case, ws0<c, ws1<d, ws2<e, which meets the condition for 2-dimensional encoding. Therefore, 2-dimensional encoding is selected. That is, ena and enb are viewed as a 2-dimensional vector, and encoding is performed according to the 2-dimensional vector.

If: ra=1, rb=0, rc=0, rd=1; 3.

va=1, vb=0, vc=1, vd=3;

la=1, lb=0, lc=5, ld=0;

cra=0, crb=1, crc=1, crd=0;

Then, through calculation, it is obtained that: ev=9, er=28, el=126, esl=2;

Then: (ev+esl)=31>a and (er+el)=128>b; in this case, only 2-dimensional or 1-dimensional encoding can be selected.

Through further calculation, it is obtained that:

ws0=2, ws1=134, ws2=4

In this case, ws0<c, ws1>d, ws2<e, which does not meet the condition for 2-dimensional encoding. Therefore, 1-dimensional encoding is selected. That is, ena is viewed as a 1-dimensional vector, and encoding is performed according to the 1-dimensional vector.

From the preceding flow, it can be seen that in this embodiment, the energy collection ev, esl, er, and el is obtained according to processed spectral coefficients. If (ev+vs1)<a and (er+e1)<b, the encoding dimensionality is determined as 4-dimensional; if the condition of (ev+vs1)<a and (er+el)<b is not met, an energy collection ws0, ws1, and ws3 is obtained; if ws0<c, ws1<d, and ws3<e, the encoding dimensionality is determined as 2-dimensional; otherwise, the encoding dimensionality is determined as 1-dimensional.

Case 2: when pst=0 or 2

In this case, the spectral coefficient to be encoded uses 1-dimensional or 2-dimensional vector encoding. This is divided into two cases:

1. When pst=0, the context model is shown in FIG. 10. In this case, spectral coefficients ena and enb to be processed use 1-dimensional or 2-dimensional encoding. The specific judgment flow is shown in FIG. 11.

In this embodiment, a variable collection contains ws0 and ws1, and a threshold collection contains c and d. Assuming that the thresholds are respectively: c=35 and d=152, the methods for calculating energy variables ws0 and ws1 are as follows:

ws0=|va|\hat{0}3+|vb|\hat{0}3;

ws1=|la|\hat{0}3+|lb|\hat{0}3+|lc|\hat{0}3+|ld|\hat{0}3+|ld|\hat{0}3+|vc|\hat{0}3+|vd|\hat{0}3;

If va=2, vb=1, vc=0, vd=1; la=2, lb=1, lc=2, ld=1:

ws0=9<35; ws1=19<152; in this case, 2-dimensional encoding is selected; that is, ena and enb are viewed as a 2-dimensional vector, and encoding is performed according to the 2-dimensional vector.

If va=2, vb=1, vc=2, vd=3; la=6, lb=0, lc=0, ld=1:

ws0=9<35; ws1=252>152; in this case, 1-dimensional encoding is selected; that is, ena is viewed as a 1-dimensional vector, and encoding is performed according to the 1-dimensional vector.

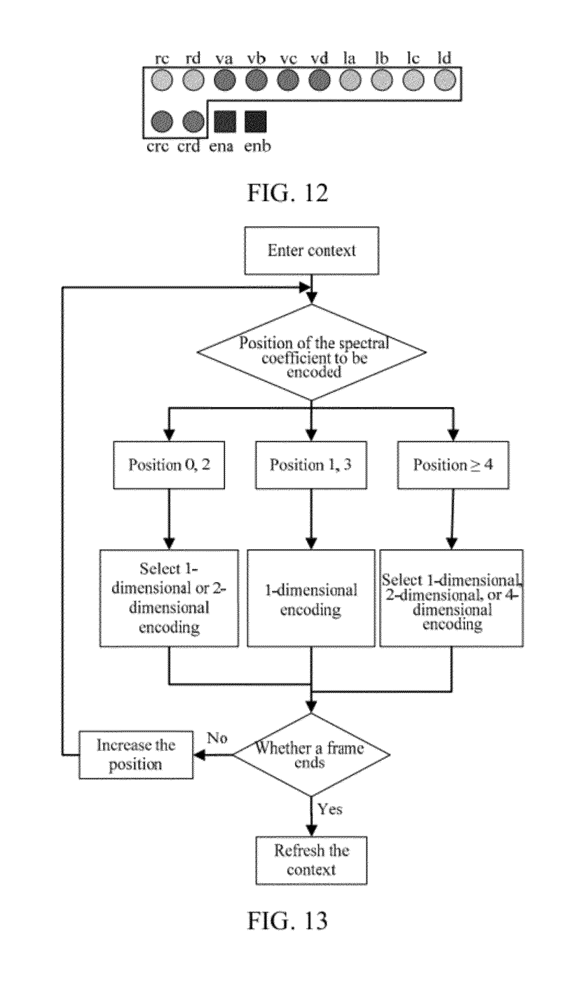

2. When pst=2, the context model is shown in FIG. 12. In this case, spectral coefficients ena and enb to be processed use 1-dimensional or 2-dimensional encoding. The specific judgment flow may use the method shown in FIG. 11.

In this embodiment, assuming that the values of constants are respectively: c=27 and d=343. The methods for calculating ws0 and ws1 are as follows:

ws0=|va|\hat{0}3+|vb|\hat{0}3++|crc|\hat{0}3+|crd|\hat{0}3;

ws1=|la|\hat{0}3+|lb|\hat{0}3+|lc|\hat{0}3+|ld|\hat{0}3+|vc|\hat{0}3+|vd|\hat{0}3+|rc|\hat{0}3+|rd|\hat{0}3;

If va−2, vb−1, vc−0, vd−1; la=2, lb=1, lc=2, ld=1, rc=1, rd=0, slc=1, sld=0:

ws0=10<27; ws1=20<343; in this case, 2-dimensional encoding is selected; that is, ena and enb are viewed as a 2-dimensional vector, and encoding is performed according to the 2-dimensional vector.

If va=2, vb=1, vc=2, vd=0; la=6, lb=0, lc=0, ld=5, rc=1, rd=0, slc=1, sld=0:

ws0=10<27; ws1=350>343; in this case, 1-dimensional encoding is selected; that is, ena is viewed as a 1-dimensional vector, and encoding is performed according to the 1-dimensional vector.

3: When pst=1 or 3, 1-dimensional encoding is used forcibly.

FIG. 13 is a flowchart of another method for mixed dimensionality encoding and decoding provided in an embodiment of the present invention. This embodiment takes a decoding end as an example, uses average value and variance as variables, combines position, average value, and variance, and describes the preceding technical scheme by using specific values:

First, context is entered. This context is obtained by mapping the previous decoded frame according to the length of the current frame to be decoded. Then, a dimensionality of the spectral coefficient to be decoded is selected according to the position of the current spectral coefficient to be decoded and according to decoded spectral coefficients, and the spectral coefficient to be decoded is decoded according to the selected dimensionality. After the decoding of the current spectral coefficient to be decoded is completed, the position counter increases to update the current spectral coefficient to be decoded. Then, the preceding process of selecting a dimensionality for a spectral coefficient according to the position of the current spectral coefficient to be decoded is repeated until the decoding of the current frame to be decoded is completed. After the decoding of the current frame to be decoded is completed, the context is refreshed to prepare for decoding a next frame.

In this embodiment, when the spectral coefficient to be decoded is in position 0 or 2, the current spectral coefficient to be decoded may select 1-dimensional or 2-dimensional decoding; when the spectral coefficient to be decoded is in position 1 or 3, the current spectral coefficient to be decoded can select 1-dimensional decoding; when the spectral coefficient to be decoded is in a position after 4, the current spectral coefficient to be decoded may select 4-dimensional decoding, 2-dimensional, or 1-dimensional decoding.

Assuming that the position variable of the current spectral coefficient to be decoded is pst, according to the preceding flowchart, three branch cases are provided:

Case 1: when pst≧4

The context model is shown in FIG. 8, where: ena, enb, enc, and end are spectral coefficients to be decoded, that is, the number of spectral coefficients to be decoded is 4; other 16 spectral coefficients, that is, ra, rb, rc, rd, va, vb, vc, vd, la, lb, lc, ld, cra, crb, crc, and crd, are 16 context spectral coefficients of the spectral coefficients to be decoded, that is, the selected decoded spectral coefficients; the 16 decoded spectral coefficients are used to predict the dimensionalities of spectral coefficients to be decoded, that is, ena, enb, enc, and end.

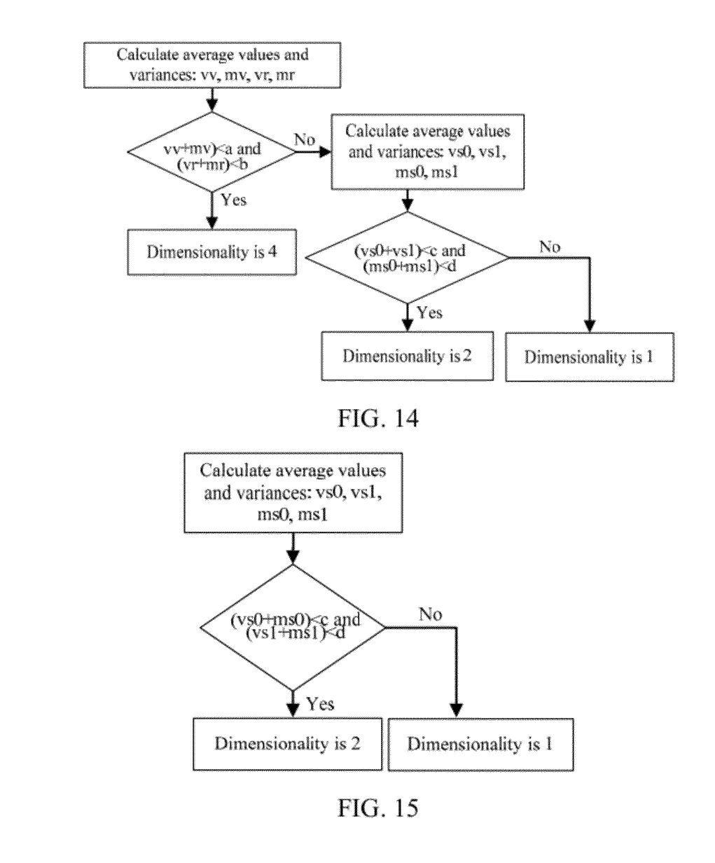

As shown in FIG. 14, in this embodiment, the types of variables are average value and variance. The variable collections include a first variable collection vv, my, vr, mr, and a second variable collection vs0, vs1, ms0, ms1. The threshold collections include a first threshold collection a, b, and a second threshold collection c, d, where a, b, c, and d are constants, whose values are obtained through experiments.

Variables vv, vr, vs0, and vs1 are variances of a plurality of encoded spectral coefficients in the neighboring areas of the spectral coefficient to be processed. Variables my, mr, ms0, and ms1 are average values of a plurality of encoded spectral coefficients in the neighboring areas of the spectral coefficient to be processed. The calculation methods are as follows:

mv=(|va|+|vb|+|vc|+|vd|+|cra|+|crb|+|crc|+|vrd|)/8;

vv=((|va|−mv)\hat{0}2+(|va|−mv)\hat{0}2+(|vc|−mv)\hat{0}2+(|vd|−mv)\hat{0}2+(|cra|−mv)\hat{0}2+(|crb|−mv)\hat{0}2+(|crc|−mv)\hat{0}2+(|crd|−mv)\hat{0}2)/8;

mr=(|la|+|lb|+|lc|+|ld|+|ra|+|rb|+|rc|+|rd|)/8;

vr=((|la|−mr)\hat{0}2+(|lb|−mr)\hat{0}2+(|lc|−mr)\hat{0}2+(|ld|−mr)\hat{0}2+(|ra|−mr)\hat{0}2+(|rb|−mr)\hat{0}2+(|rc|−mr)\hat{0}2+(|rd|−mr)\hat{0}2)/8;

ms0=(|va|+|vb|+|crc|+|crd|)/4;

vs0=((|va|−ms0)\hat{0}2+(|vb|−ms0)\hat{0}2+(|crc|−ms0)\hat{0}2+(|crd|−ms0)\hat{0}2)/4;

ms1=(|la|+|lb|+|lc|+|ld|+|ra|+|rb|+|rc|+|rd|+|vc|+|vd|+|cra|+|crb|)/12;

vs1=((|la|−ms1)\hat{0}2+(|lb|−ms1)\hat{0}2+(|lc|−ms1)\hat{0}2+(|ld|−ms1)\hat{0}2+(|ra|−ms1)\hat{0}2+(|rb|−ms1)\hat{0}2+(|rc|−ms1)\hat{0}2+(|rd|−ms1)\hat{0}2+(|vc|−ms1)\hat{0}2(|vd|−ms1)\hat{0}2+(|cra|−ms1)\hat{0}2+(|crb|−ms1)\hat{0}2)/12.

If (vv+mv)<a and (vr+mr)<b; in this case, 4-dimensional encoding is selected, that is, ena, enb, enc, and end are viewed as a 4-dimensional vector and encoding is performed according to the 4-dimensional vector. If (vv+mv)<a and (vr+mr)<b, 2-dimensional or 1-dimensional decoding is selected.

Further, if (vs0+vs1)<c and (ms0+ms1)<d, 2-dimensional decoding is selected, that is, ena and enb are viewed as a 2-dimensional vector, and decoding is performed according to the 2-dimensional vector; otherwise, 1-dimensional decoding is selected, that is, ena is viewed as a 1-dimensional vector, and decoding is performed according to the 1-dimensional vector.

From the preceding flow, it can be seen that in this embodiment, the average value and variance collection vv, my, yr, and mr is obtained according to processed spectral coefficients. If (vv+mv)<a and (vr+mr)<b, the encoding dimensionality is determined as 4-dimensional; if the condition of (vv+mv)<a and (vr+mr)<b is not met, an average value and variance collection vs0, vs1 , ms0, and ms1 is obtained; if (vs0+vs1)<c and (ms0+ms1)<d, the encoding dimensionality is determined as 2-dimensional; otherwise, the encoding dimensionality is determined as 1-dimensional.

Case 2: when pst=0 or 2

In this case, the spectral coefficient to be decoded uses 1-dimensional or 2-dimensional vector decoding. This is divided into two cases:

1. When pst=0, the context model is as shown in FIG. 10. In this case, spectral coefficients ena and enb to be processed use 1-dimensional or 2-dimensional decoding. The specific judgment flow is shown in FIG. 15.

In this embodiment, a variable collection contains vs0, vs1, ms0, and ms1, and a threshold collection contains c and d. The methods for calculating vs0, vs1, ms0, and ms1 are as follows:

ms0=(|va|+|vb|)/2;

vs0=((|va|−ms0)\hat{0}2+(|vb|−ms0)\hat{0}2)/2;

ms1=(|la|+|lb|+|lc|+|ld|+|vc|+|vd|)/6;

vs1=((|la|−ms1)\hat{0}2+|lb|−ms1)\hat{0}2+|lc|−ms1)\hat{0}2+|ld|−ms1)\hat{0}2+(|vc|−ms1)\hat{0}2+(|vd|−ms1)\hat{0}2)/6

If (vs0+ms0)<c and (vs1+ms1)<d, 2-dimensional decoding is selected, that is, ena and enb are viewed as a 2-dimensional vector, and decoding is performed according to the 2-dimensional vector; otherwise, 1-dimensional decoding is selected, that is, ena is viewed as a 1-dimensional vector and decoding is performed according to the 1-dimensional vector.

2. When pst=2, the context model is as shown in FIG. 12. In this case, spectral coefficients ena and enb to be decoded use 1-dimensional or 2-dimensional decoding. The specific judgment flow may use the method shown in FIG. 15.

In this embodiment, the methods for calculating vs0, vs1, ms0, and ms1 are as follows:

ms0=(|va|+|vb|+|crc|+|crd|)/4;

vs0=((|va|−ms0)\hat{0}2+(|vb|−ms0)\hat{0}2+(|crc||ms0)\hat{0}2+(|crd|−ms0)\hat{0}2)/4;

ms1=(|la|+|lb|+|lc|+|ld|+|vc|+|vd|+|rc|+|rd|)/8;

vs1=((|la|−ms1)\hat{0}2+|lb|−ms1)\hat{0}2+|lc|−ms1)\hat{0}2+|ld|−ms1)\hat{0}2+(|vc|−ms1)\hat{0}2+(vd|−ms1)\hat{0}2+(|vd|−ms1)\hat{0}2(|rc|−ms1)\hat{0}2+(|rd|−ms1)\hat{0}2)/8.

If (vs0+ms0)<c and (vs1+ms1)<d, 2-dimensional decoding is selected, that is, ena and enb are viewed as a 2-dimensional vector, and decoding is performed according to the 2-dimensional vector ; otherwise, 1-dimensional decoding is selected, that is, ena is viewed as a 1-dimensional vector and decoding is performed according to the 1-dimensional vector.

3: When pst=1 or 3, 1-dimensional decoding is used forcibly.

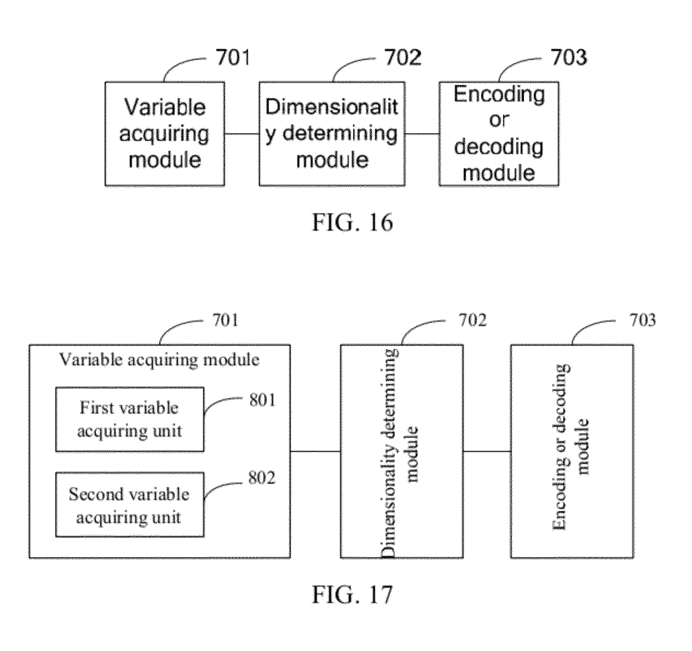

FIG. 16 is a structural diagram of an embodiment of an apparatus for mixed dimensionality encoding and decoding. The apparatus includes:

a variable acquiring module 701, configured to obtain at least one variable collection through calculation according to a processed spectral coefficient;

a dimensionality determining module 702, configured to determine a processing dimensionality for a spectral coefficient to be processed, according to a relationship between the at least one variable collection and a corresponding threshold collection; and

an encoding and decoding module 703, configured to perform, according to a selected dimensionality, encoding or decoding under the dimensionality on the spectral coefficient to be processed.

The apparatus provided in the embodiment of the present invention adopts the technical means of obtaining at least one variable collection through calculation according to a processed spectral coefficient, determining a processing dimensionality for a spectral coefficient to be processed, according to a relationship between the at least one variable collection and a corresponding threshold collection, and performing, according to a selected dimensionality, encoding or decoding under the dimensionality on the spectral coefficient to be processed, and uses different processing dimensions for different spectral coefficients, improving the encoding and decoding efficiency.

In this embodiment, the variables obtained by the variable acquiring module 701 include at least one of position, energy, average value, variance, mean square error, minimum variance, slope, divergence factor, and dispersion.

In certain implementation ways, the dimensionality determining module 702 is further configured to determine a processing dimensionality of the spectral coefficient to be processed by combining a position of the spectral coefficient to be processed. If the position of the spectral coefficient to be processed in the frame to be processed is larger than or equal to the position threshold, the processing dimensionality is selected from a first range. If the position of the spectral coefficient to be processed in the frame to be processed is smaller than the position threshold, the processing dimensionality is selected from a second range.

In certain implementation ways, as shown in FIG. 17, the variable acquiring module 701 includes a first variable acquiring unit 801 and a second variable acquiring unit 802. The first variable acquiring unit 801 is configured to obtain a first variable collection corresponding to a first threshold collection, and the second variable acquiring unit 802 is configured to obtain a second variable collection corresponding to a second threshold collection.

The following outlines the flow of the apparatus for mixed dimensionality encoding and decoding provided in an embodiment of the present invention in executing the method provided in the preceding embodiment by taking the case where the variable acquiring module 701 includes the first variable acquiring unit 801 and the second variable acquiring unit 802 as an example:

The first variable acquiring unit 801 obtains the first variable collection according to processed spectral coefficients.

The dimensionality determining module 702 judges whether variables or variable combinations in the first variable collection are all smaller than corresponding thresholds in the first threshold collection; if the result is yes, determine the processing dimensionality of the spectral coefficient to be processed as a first dimensionality;

If the result is no, the second variable acquiring unit 802 obtains a second variable collection according to processed spectral coefficients, and then the dimensionality determining module 702 judges whether variables or variable combinations in the second variable collection are all smaller than corresponding thresholds in the second threshold collection; if the result is yes, determine the processing dimensionality of the spectral coefficient to be processed as a second dimensionality; if the result is no, determine the processing dimensionality of the spectral coefficient to be processed as a third dimensionality.

In certain implementation ways, the variable acquiring module 701 is only configured to obtain a variable collection, so that no units need to be further divided. In this case, the variable acquiring module 701 obtains a variable collection according to processed spectral coefficients, and the dimensionality determining module 702 judges whether obtained variables or variable combinations in the variable collection are all smaller than corresponding thresholds in the threshold collection; if the result is yes, determine the processing dimensionality of the spectral coefficient to be processed as a fourth dimensionality; if the result is no, determine the processing dimensionality of the spectral coefficient to be processed as a fifth dimensionality.

It needs to be noted that the setting of the comparison relationship does not confine the present invention, for example, being smaller than may also be being equal to or smaller than, and being greater than may also be being equal to or greater than.

The apparatus for mixed dimensionality encoding and decoding in this embodiment is configured to implement the preceding method for mixed dimensionality encoding and decoding. As the preceding embodiments describe the method for mixed dimensionality encoding and decoding, the process of executing the method by the apparatus for mixed dimensionality encoding and decoding is outlined but not described in detail. For details about the method, see the content in preceding embodiments for the method.

Those killed in the art may understand that all or part of the steps in the preceding method may be completed by using a program to instruct the hardware. The program can be stored in a storage medium that can be read by a computer. The procedure for executing the program can include the flows of the methods provided in an embodiment of the present invention. The storage medium can be disk tape, compact disk, Read-Only Memory (ROM), or Random Access Memory (RAM).

The preceding are specific implementation methods of the present invention. Those skilled in the art may make various modifications and variations to the invention without departing from the principle of the invention. The invention is intended to cover the modifications and variations provided that they fall in the protection scope defined by the following claims or their equivalents.

What is claimed is:

1. A method for mixed dimensionality encoding and decoding, comprising:
obtaining at least one variable collection through calculation according to a processed spectral coefficient;
determining a processing dimensionality for a spectral coefficient to be processed according to a relationship between the at least one variable collection and a corresponding threshold collection; and
performing, according to a selected dimensionality, encoding or decoding under the dimensionality on the spectral coefficient to be processed.

2. The method according to claim 1, wherein the variable comprises:
at least one of position, energy, average value, variance, mean square error, minimum variance, slope, divergence factor, and dispersion.

3. The method according to claim 1, wherein:
the processing dimensionality for the spectral coefficient to be processed is determined by combining a position of the spectral coefficient to be processed.

4. The method according to claim 3, further comprising:
if the position of the spectral coefficient to be processed in a frame to be processed is larger than or equal to a position threshold then selecting the processing dimensionality from a first range.

5. The method according to claim 1, wherein:
the at least one variable collection comprises a first variable collection and a second variable collection; and
the first variable collection and the second variable collection correspond to a first threshold collection and a second threshold collection respectively.

6. The method according to claim 5, wherein the obtaining at least one variable collection through calculation according to the processed spectral coefficient and the determining the processing dimensionality for the spectral coefficient to be processed, according to the relationship between the at least one variable collection and the corresponding threshold collection comprise:
obtaining the first variable collection according to processed spectral coefficients; and
if variables or variable combinations in the first variable collection are all smaller than corresponding thresholds in the first threshold collection then determining the processing dimensionality of the spectral coefficient to be processed as a first dimensionality.

7. The method according to claim 5, wherein the obtaining at least one variable collection through calculation according to the processed spectral coefficient and the determining the processing dimensionality for the spectral coefficient to be processed, according to the relationship between the at least one variable collection and the corresponding threshold collection comprise:
obtaining the first variable collection according to processed spectral coefficients;
if the variables or variable combinations in the first variable collection are not all smaller than the corresponding thresholds in the first threshold collection then obtaining a second variable collection; and
if variables or variable combinations in the second variable collection are all smaller than corresponding thresholds in a second threshold collection, determining the processing dimensionality of the spectral coefficient to be processed as a second dimensionality.

8. The method according to claim 5, wherein the obtaining at least one variable collection through calculation according to the processed spectral coefficient and the determining the processing dimensionality for the spectral coefficient to be processed, according to the relationship between the at least one variable collection and the corresponding threshold collection comprise:
obtaining the first variable collection according to processed spectral coefficients;
if the variables or variable combinations in the first variable collection are not all smaller than the corresponding thresholds in the first threshold collection then obtaining the second variable collection; and
if the variables or variable combinations in the second variable collection are not all smaller than the corresponding thresholds in the second threshold collection then determining the processing dimensionality of the spectral coefficient to be processed as a third dimensionality.

9. The method according to claim 3, further comprising:
if the position of the spectral coefficient to be processed in the frame to be processed is smaller than the position threshold then selecting the processing dimensionality from a second range.

10. The method according to claim 1, wherein the obtaining at least one variable collection through calculation according to the processed spectral coefficient and the determining the processing dimensionality for the spectral coefficient to be processed, according to the relationship between the at least one variable collection and the corresponding threshold collection comprise:
obtaining the variable collection according to processed spectral coefficients; and
if variables or variable combinations in an obtained variable collection are all smaller than corresponding thresholds in the corresponding threshold collection then determining the processing dimensionality of the spectral coefficient to be processed as the fourth dimensionality.

11. The method according to claim 1, wherein the obtaining at least one variable collection through calculation according to the processed spectral coefficient and the determining the processing dimensionality for the spectral coefficient to be processed, according to the relationship between the at least one variable collection and the corresponding threshold collection comprise:
obtaining the variable collection according to processed spectral coefficients; and
if variables or variable combinations in an obtained variable collection are not all smaller than corresponding thresholds in the corresponding threshold collection then determining the processing dimensionality of the spectral coefficient to be processed as a fifth dimensionality.

12. An apparatus for mixed dimensionality encoding and decoding, comprising:
a variable acquiring module, configured to obtain at least one variable collection through calculation according to a processed spectral coefficient;
a dimensionality determining module, configured to determine a processing dimensionality for a spectral coefficient to be processed, according to a relationship between the at least one variable collection and a corresponding threshold collection; and
an encoding and decoding module, configured to perform, according to a selected dimensionality, encoding or decoding under the dimensionality on the spectral coefficient to be processed.

13. The apparatus according to claim 12, wherein:
the dimensionality determining module is further configured to determine a processing dimensionality of the spectral coefficient to be processed by combining a position of the spectral coefficient to be processed.

14. The apparatus according to claim 12, wherein the variable acquiring module comprises:
a first variable acquiring unit, configured to obtain a first variable collection corresponding to a first threshold collection; and
a second variable acquiring unit, configured to obtain a second variable collection corresponding to a second threshold collection.
